(19) United States
(12) Patent Application Publication
(10) Pub. No.: US 2014/0222638 A1
(43) Pub. Date: Aug. 7, 2014

(54) System and Method for Merchant Transfer of a Forward-Sold Good Contract

(71) Applicant: MASTERCARD INTERNATIONAL INCORPORATED, Purchase, NY (US)

(72) Inventor: Peter Groarke, Dublin (IE)

(73) Assignee: MASTERCARD INTERNATIONAL INCORPORATED, Purchase, NY (US)

(21) Appl. No.: 13/759,481

(22) Filed: Feb. 5, 2013

(51) Int. Cl. G06Q 40/04

(52) U.S. Cl. CPC G06Q 40/04
USPC 705/37

(57) ABSTRACT

A system and a method are provided that each have the capability for immediate merchant transfer of a forward-sold good contract. At the time of purchase of a transferable/resellable forward-sold good, a merchant strike price is set by the merchant. If the merchant strike price is met by a bidding merchant, this allows transfer/resale of the forward-sold good contract to the bidding merchant. A system for merchant transfer of a forward-sold good contract by use of a merchant transferable website and database is also provided.

### BACKGROUND OF THE DISCLOSURE

1. Field of the Disclosure

The present disclosure relates to merchant transfer of a contract for one or more goods and/or services that will be delivered at a time other than when payment is made. More particularly, it relates to a system and a method for facilitating the merchant transfer of a forward-sold good contract.

2. Description of the Related Art

It is an established practice in several industries for merchants to sell goods or services in advance of their delivery. This is the situation for sporting events, music concerts, airline tickets, books that have yet to be published, whether in electronic or hard copy form, or the latest model of a particular smart phone. These goods or services, that are sold before they are delivered, are referred to herein as forward-sold goods. Typically, a payment card holder will be charged the price of the forward-sold good at the time of purchase.

Frequently, events occur before the goods or services are actually delivered that may have an impact upon the purchaser or may affect the desirability of the forward-sold goods that are purchased. As a general example, a ticket holder may have an unplanned pressing engagement on the day of an event or may otherwise be indisposed. As a particular example, an opera ticket holder's child may become sick on the morning of the opera and the ticket holder can no longer be available to attend the event. Another example is a particular football game between two teams may have become important in deciding which team will go to a playoff. In this case, the desirability of the ticket and its value, which could not have been anticipated at the time of the original sale by the merchant, may have changed drastically. In yet another example, the smart phone that was preordered may have received unfavorable pre-release reviews, or a competitor may have announced the release of a more desirable model.

Also, from a merchant's standpoint, events can occur which may make it desirable for a merchant to transfer an agreed contract with a purchaser to another merchant/supplier. Reasons why a merchant may want to transfer an agreed contract with a purchaser to deliver a forward-sold good to another merchant/supplier include, for example, the merchant may not have delivery capacity because of low stock levels or staffing problems or better opportunities. Conversely, a merchant/supplier may have overcapacity and wish to take on other merchants' agreed contracts to deliver a forward-sold good.

In all of these situations, it would be desirable to have a system and method for facilitating merchant transfer of a forward-sold good contract so that merchants can benefit.

### SUMMARY OF THE DISCLOSURE

There is provided a system and/or method for facilitating the merchant transfer, including immediate merchant transfer, of a contract for one or more forward-sold goods and/or services (hereinafter referred to as a “good” or “goods”).

There is also provided such a system and/or method that allows conditions of the merchant transfer, including immediate merchant transfer, of a contract for such forward-sold goods.

There is further provided such a system and/or method that facilitates the settling of accounts involving merchant transfer, including immediate merchant transfer, of a contract for forward-sold goods so that the merchant of forward-sold goods transfers a contract, including consideration received from a purchaser, for the forward-sold goods to a new merchant, and the new merchant assumes the contract and thereby becomes the new supplier for the forward-sold goods.

The present disclosure has a computer readable non-transitory storage medium that stores instructions of a computer program that when executed by a computer system results in performance of steps of the method for facilitating the merchant transfer of a contract for one or more forward-sold goods.

The present disclosure has such a storage medium that results in an immediate merchant transfer of a contract for one or more forward-sold goods.

### BRIEF DESCRIPTION OF THE DRAWINGS

FIG. 1 is a diagram of a four party payment card system.

FIG. 2 is a block diagram of a portion of a payment card system modified in accordance with one aspect of the present disclosure.

FIG. 3 is a flow chart representing the manner in which acquired data is filtered to select relevant data and to preserve confidentiality.

FIG. 4 is a flow chart illustrating the manner in which the system in accordance with the present disclosure is used by a merchant to facilitate immediate transfer/resale of a forward-sold good contract.

FIG. 5 is a flow chart illustrating the manner in which the system in accordance with the present disclosure is used by a merchant to review and accept bids for immediate transfer/resale of a forward-sold good contract.

FIG. 6 is a flow chart illustrating the manner in which the system in accordance with the present disclosure is used by a merchant to facilitate transfer/resale of a forward-sold good contract.

FIG. 7 is a flow chart illustrating the manner in which the system in accordance with the present disclosure is used by a merchant to review and accept bids for transfer/resale of a forward-sold good contract.

FIG. 8 is a flow chart illustrating the manner in which the system in accordance with the present disclosure is used by a merchant of goods or services to find goods contracts available for transfer/resale, and to make a purchase of such goods contracts.

A component or a feature that is common to more than one drawing is indicated with the same reference number in each of the drawings.

### DESCRIPTION OF A PREFERRED EMBODIMENT

The system and method of this disclosure allows merchants of forward-sold goods that have been purchased by payment cards to pass on their contract to deliver to other merchants/suppliers. The original merchant seller of the forward-sold good contract deems a particular forward-sold good contract to be merchant transferable. This will be made clear to cardholders purchasing the forward-sold good.

As used herein, “contract” is the forward-sold good contract between a merchant and purchaser, or between merchants, that comprises payment card transactions and other transaction information including terms and conditions of the payment card transactions.

After the original purchase and before a transferable/resellable close date/time, the original merchant may wish to sell the forward-sold good contract to another merchant/supplier. This may be for a value above, equal or below the original sale price. In accordance with this disclosure, there are two mechanisms for transferring/reselling a merchant transferable forward-sold good contract to another merchant/supplier. One mechanism involves immediate merchant transfer/resale in which the merchant sets a strike price which gets registered on the merchant transferable website as more fully described hereinbelow. Another mechanism involves the use of a merchant transferable website/database as described more fully hereinbelow.

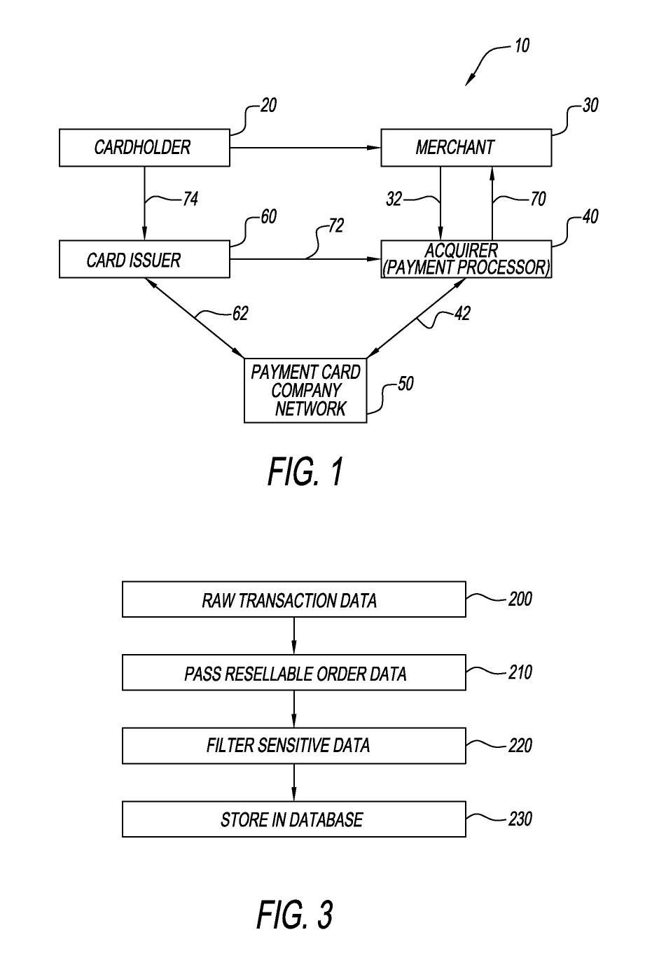

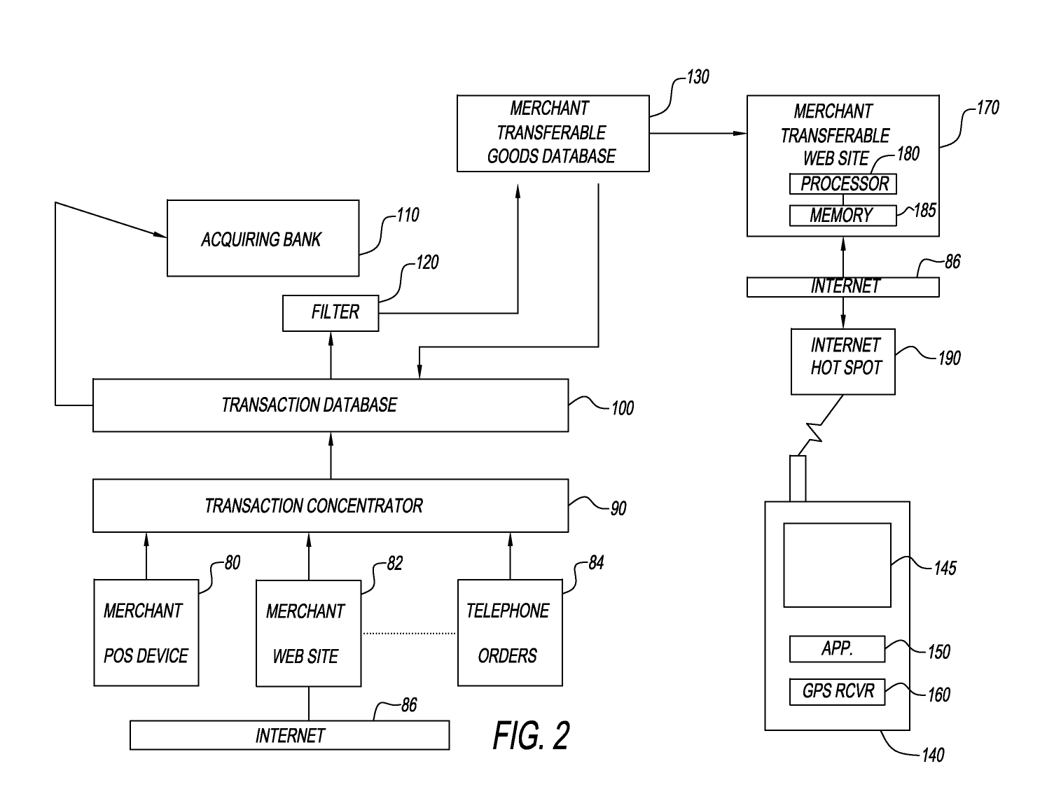

Referring to the drawings and, in particular, FIG. 1, there is shown a four party payment (credit, debit or other) card system generally represented by reference numeral 10. In card system 10, cardholder 20 submits the payment card to the merchant 30. The merchant's point of sale (POS) device (80 in FIG. 2) communicates 32 with his acquiring bank or acquirer 40, which acts as a payment processor. The sale can be a purchase of one or more goods and/or services (again hereinafter referred to as “good” or “goods”). The acquirer 40 initiates, at 42, the transaction on the payment card network 50. The payment card network 50 routes, via 62, the transaction to the issuing bank or card issuer 60, which is identified using information in the transaction message, more fully described below. The card issuer 60 approves or denies an authorization request, and then routes, via the payment card network 50, an authorization response back to the acquirer 40. The acquirer 40 sends approval to the POS device of the merchant 30. Thereafter, seconds later, the cardholder completes the purchase and receives a receipt.

The account of the merchant 30 is credited, via 70, by the acquirer 40. The card issuer 60 pays, via 72, the acquirer 40. Eventually, the cardholder 20 pays, via 74, the card issuer 60.

Referring to FIG. 2, each merchant has on its premises at least one merchant POS device 80, such as a card swiping machine for initiating customer transactions. A POS device 80 is of a type well known in the art, and generally has a keyboard data entry pad for entering data when a card's magnetic coding becomes difficult to read. A sale may also be made when a customer accesses a merchant's web site 82 via the Internet 86, and makes a purchase in a manner well known in the art. A merchant may also process a telephone order 84 by entering customer information in a device having a keypad similar to merchant POS device 80, including payment card data.

Data representative of a financial transaction from merchant POS device 80, merchant web site 82 and from telephone order 84, are transmitted by a suitable network to a transaction concentrator 90, for a given geographic area that concentrates the transaction information. There are many transaction concentrators 90, preferably for different geographic areas. Transaction concentrator 90 forwards the data to a transaction database 100 that stores information concerning the transactions. Data from transaction database 100 is routed to a respective acquiring bank 110 that, in turn, routes the information so that transactions are properly completed using the system illustrated in FIG. 1.

Referring to FIG. 2, data for a relatively large geographic region may be stored in a single database at a central location. This facilitates the transfer/resale of a forward-sold good contract by making information available over a large geographic region, including advantageously, the entire world.

Information that is exchanged across the network for each payment card financial transaction message includes the following characteristics: acquirer identifier/card accepter identifier (the combination of which uniquely defines the merchant); merchant address (i.e., full address and or GPS data); merchant category code (also known as card acceptor business code) that is an indication of the type of business the merchant is involved in (for example, a gas station); local transaction date and time; cardholder base currency (i.e., U.S. Dollars, Euro, Yen, etc.); the transaction environment or method being used to conduct the transaction (as more fully explained below); and product specific data, such as SKU line item data, and cost of the transaction.

Transaction records stored in transaction database 100 contain information that is highly confidential and must be maintained to prevent fraud and identity theft. The transaction records stored in transaction database 100 are sent through a filter 120 (FIG. 2) that removes confidential information, but retains records concerning merchant identification and the occurrence of transactions at various times, preferably in real time. The filtered data is stored in a merchant transferable goods database that may be accessed as described below. The data of the database may be stored in any type of memory, including a hard drive, a flash memory, on a CD, in a RAM, or any other suitable memory.

An illustrative approach to accessing the data involves a mobile telephone. However, it will be understood that there are various other approaches, technologies and pathways that can be used. These include various technologies that may send alerts, such as telephone calls, text messages, instant messages and e-mails, when a forward-sold good or service becomes available for purchase. In instances where the speed of the response is important, as for example when tickets to a sold out concert become available for resale, a so-called “push” technology should be used, where information is “pushed” out to consumers that have access to the system, rather than waiting until the consumer decides to again check for the availability of the good for transfer/resale.

A mobile telephone 140 having a display 145 may have a series of applications or applets thereon, including an applet or application program (hereinafter “application”) 150 for use with the embodiments described herein. Application 150 can be a browser or a more sophisticated application that provides payment card information, for example, a digital wallet.

Mobile telephone 140 may be used to access a merchant transferable website 170, via an Internet connected Wi-Fi hot spot 190 connected to the Internet 86 (or by any telephone network, such as a 3G or 4G system, on which mobile telephone 140 communicates) by using application 150. Merchant transferable website 170 is linked to merchant transferable goods database 130 so that authorized merchants of merchant transferable website 170 may have access to the data contained therein. The manner in which that access is exploited, in accordance with the present disclosure, is described below.

The system and method described herein can be used with a mobile device. However, it will be understood that merchant transferable web site 170 may be accessed from a home or business computer, or a personal digital assistant, or any other Internet connected device, such as, a tablet or device (for example, an iPad®).

When merchant transferable web site 170 is accessed and the data in merchant transferable goods database 130 is supplemented by a transfer transaction, update data concerning the new merchant is sent from merchant transferable goods database 130 to transaction database 100.

FIG. 3 describes the operation of filter 120 of FIG. 2. The raw transaction data usually exchanged over the network is acquired at 200. At 210, only transaction data that has been coded for transfer (resellable) of the good purchased is passed for further processing. At 220, customer sensitive information, such as the credit card number/expiration date and any personally identifiable information, is filtered or removed. At 230, the remaining data is stored in merchant transferable goods database 130 of FIG. 2. After a time, when the forward-sold good has been delivered and used by a final purchaser, data that is no longer current or has become “old” or dated, is removed from the database. This serves to conserve space in the memory associated with merchant transferable goods database 130. However, data concerning subsequent transfers of the purchased goods is sent to transaction database 100 (shown in FIG. 2), so that all data concerning a transaction is preserved.

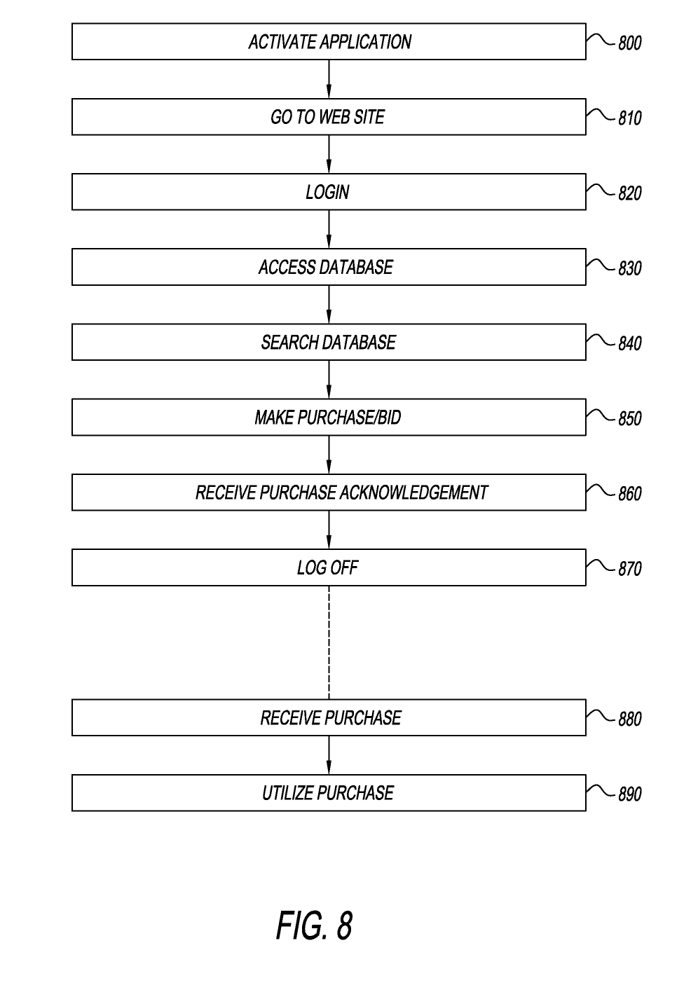

FIG. 8 illustrates the manner the system of the present disclosure is used by a merchant/supplier of one or more goods (or services) to find contracts available for transfer, and to make a purchase. The merchant/supplier activates an application at 800 on a mobile telephone or a computer with access 810 to the Internet, such as merchant transferable web site 170 of FIG. 2. The merchant/supplier logs into merchant transferable web site 170 at 820. At 830, the merchant/supplier accesses the merchant transferable goods database 130, and using the application on a mobile telephone or computer, does one or more searches of the merchant transferable database at 840 for contracts available for transfer that are of interest to the merchant/supplier. The database at 840 includes the strike price set by the original merchant at the time of purchase of the transferable forward-sold good. At 850, the merchant/supplier makes a purchase or bids on one or more goods' contracts of interest. An acknowledgement of the bid or purchase is received at 860. The merchant/supplier then logs off 870.

At a later time, the merchant/supplier receives the good contract purchased 880. The merchant/supplier is then free to utilize the purchase 890.

It will be understood that when a user, such as a merchant/supplier, purchases the forward-sold good contract, that merchant may again transfer/sell the forward-sold good contract. If there is still time before an event and the number of times a transfer/resale is permitted has not been exceeded, the current merchant may access merchant transferable web site 170 to transfer/resell the contract again. If the contract is not transferred/resold, the merchant becomes the final owner of the contract. When the time for transfer/resale has expired, the merchant can access transaction database 100, which was updated for each transfer/sale, using an application program interface (API), to determine who the final owner is, and to deliver the contract to the final owner. This will be accomplished using the primary account number (PAN) of the final owner. In some cases, the final owner will use the payment card corresponding to that account to obtain delivery of the contract.

The final merchant owner of the contract will then deliver the forward-sold good/service to the purchaser of the forward-sold good/service from the original merchant. As part of the original transaction, the purchaser will provide delivery information to the original merchant at the time of purchase. To enable proper and timely delivery of the forward-sold good/service, the original merchant will provide the delivery information of the purchaser into the merchant transferable goods database or the merchant transferable website. The final merchant owner of the contract can then access the merchant transferable goods database or the merchant transferable website to readily obtain the delivery information of the purchaser, and make delivery to the purchaser.

Typically, there is no commission involved for merchant transferable forward-sold good contracts. This is essentially a service that benefits the merchants. The implementation of the merchant transfer method is thus simpler than the resellable forward good method in that it only involves a single purchase transaction.

In the case of international transfer/resale, a currency exchange rate will become a factor. It is possible that due to changes in currency exchange rates, the current holder of a good contract that is being transferred/sold may receive a windfall, or may receive less than the expected transfer/resale price.

### System and Method Having Capability for Immediate Merchant Transfer of a Forward-Sold Good Contract

FIGS. 1-5 and 8 apply to the following embodiment that involves a system and method having capability for immediate merchant transfer of a forward-sold good contract.

At the time of purchase of a transferable/resellable forward-sold good, a “merchant strike price” is set by the merchant. If the merchant strike price is met by a bidding merchant, this allows transfer/resale of the forward-sold good contract to the bidding merchant. As used herein, “merchant strike price” is the fixed price at which the owner of the forward-sold good contract, e.g., merchant, sells the forward-sold good contract to another merchant. This obviates the need for a merchant to have to resort to a website to effect transfer/resale of the forward-sold good contract.

The merchant strike price set by the merchant at the time of purchase of a transferable/resellable forward-sold good is subject to the merchant's transfer/resale restrictions. The merchant strike price can be a higher or lower price or the same price as the price that the merchant originally sold the good. The merchant strike price along with other relevant transaction details is conveyed to a merchant transferable website 170, and therefore the forward-sold good contract is essentially immediately available for transfer/resale to another merchant.

In order to facilitate the transfer of a forward-sold good contract (which is generally at the discretion of the merchant) for each transaction, several other characteristics or parameters are also specified. These characteristics include: a strike price for the transfer purchase of the forward-sold good contract; a minimum price for the transfer purchase of the contract; the maximum price for the transfer purchase of the contract; auction parameters, such as, for example, the last time a bid may be placed for purchase of the good sold contract; a transaction number that can be used to access all data associated with the transaction including subsequent transfer of the good contract; the number of times the good contract can be transferred/resold; a text searchable, and a short descriptive name to describe the forward-sold good (or service) contract. By including these parameters, the sale of the forward-sold good contract is coded for possible transfer/resale. Further, these parameters can be entered by the merchant, as desired.

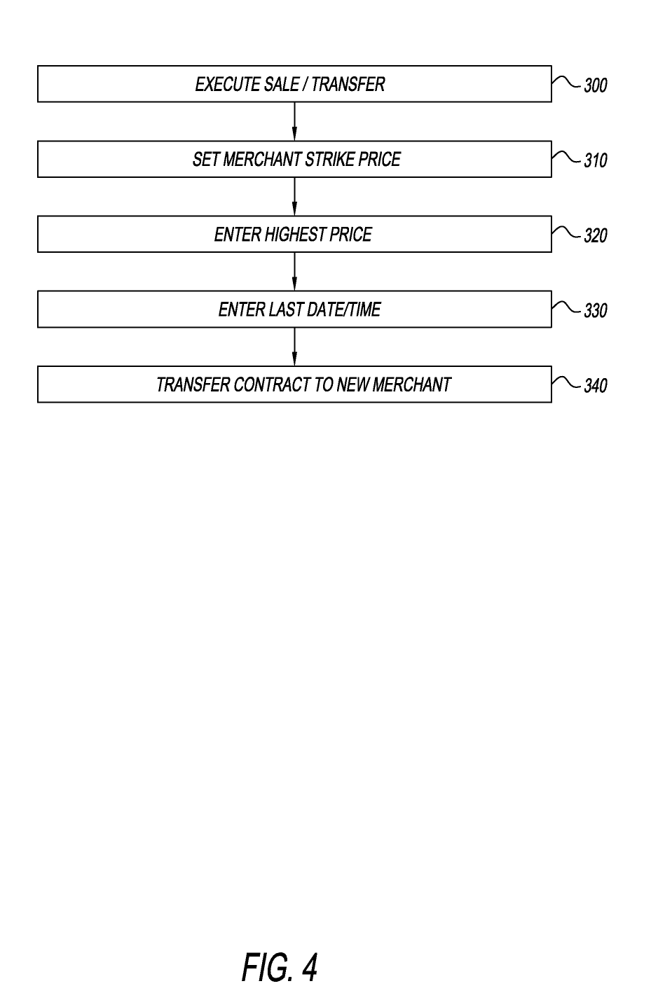

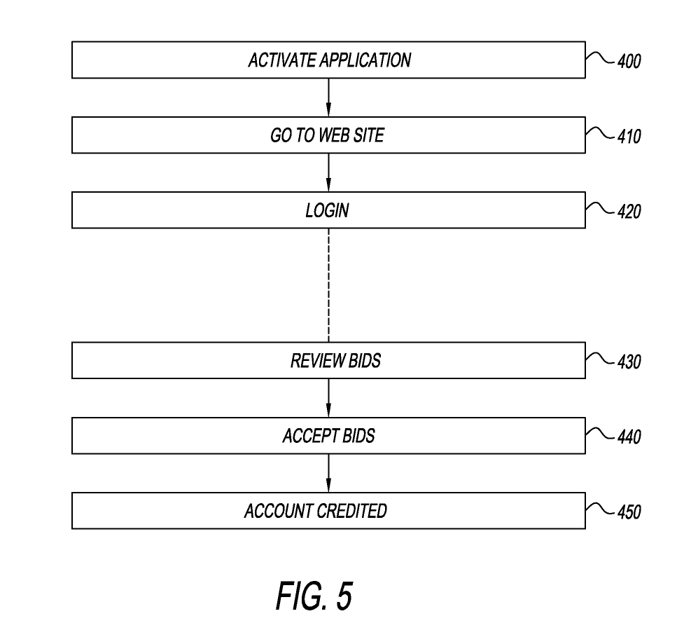

Referring again to FIG. 2, merchant transferable web site 170 has a processor 180 for assembling data from merchant transferable goods database 130 for: (a) receiving merchant input, as more fully discussed with respect to FIG. 4; (b) dealing with requests of merchants who wish to immediately transfer goods contracts, as more fully discussed with respect to FIGS. 4 and 5; and (c) dealing with requests from merchants to purchase goods contracts available for transfer, as more fully discussed with respect to FIG. 8. A memory 185, associated with merchant transferable web site 170, having a non-transitory computer readable medium, stores computer readable instructions for use by processor 180 in implementing the operation of the disclosed embodiment.

FIG. 4 illustrates the manner in which the present method or system is used by a merchant to execute a transfer 300 as described above with respect to FIG. 2. At 310, at the discretion of the merchant, a strike price for the forward-sold good is set by the merchant at the time of purchase and the sale is coded for permitting the transfer/resale of the forward-sold good contract. At 320, the merchant provides a parameter for the highest price at which the forward-sold good contract can be transferred/resold. This can be important to the merchant for two reasons: (a) the merchant can maintain some control of the price so as not to be regarded as engaging in price gouging; and (b) for some goods, such as event prices for sports events or concerts, there may be local laws (anti-scalping laws) against resale at exorbitant prices. The merchant can best determine the nature of such restrictions on resale price, and can avoid possible fines or other penalties by entering a highest resale price.

At 330, the merchant will enter a last date and time for transfer/resale, or in the case of bidding, for submitting a bid, for the good contract to be transferred/resold. There can be practical reasons for specifying a last time that the good contract can be transferred/resold. For example, in order to assure delivery, it may be necessary to stop transfer/resale one day before the flight for a ticket for a flight on an airline, or within minutes of the start of a concert, if tickets are delivered to a mobile device in the form of a bar code for use in entering the venue of the event. Assuming the good contract is transferred/resold, at 340, the merchant of forward-sold goods transfers a contract, including consideration received from a purchaser, for the forward-sold goods to a new merchant, and the new merchant assumes the contract and thereby becomes the new supplier for the forward-sold goods.

FIG. 5 illustrates the system in accordance with the present disclosure that is used by a merchant of the good contract to review and accept bids. At 400, the original merchant or current merchant of the forward-sold good contract (a user of web site 170 of FIG. 2) activates an application on a mobile telephone or a computer with access to the Internet to access at 410 web site 170. The user logs into web site 170 at 420. The merchant can review one or more bids 430 and accept one or more bids 440 if multiple goods contracts were offered for transfer. In a simple transfer/resale situation, if an offer was accepted, the merchant will be informed of the transaction when logging in or by a push technology, and the merchant account is credited at 450 with the purchase price.

### System and Method for Merchant Transfer of a Forward-Sold Good Contract

FIGS. 1-3 and 6-8 apply to the following embodiment that involves a system and method for merchant transfer of a forward-sold good contract.

This embodiment does not involve setting a strike price at the time of purchase. In this embodiment, the merchant resorts to a website to effect transfer/resale of the forward-sold good contract.

In order to facilitate the transfer/resale of a forward-sold good contract (which is generally at the discretion of the merchant) for each transaction, several other characteristics or parameters are also specified. These characteristics include: a flag indicating that the forward-sold good contract is available for transfer/resale; a minimum price for the transfer/resale purchase; the maximum price for the transfer/resale purchase; auction parameters, such as, for example, the last time a bid may be placed for purchase of the forward-sold good contract; a transaction number that can be used to access all data associated with the transaction including subsequent transfer/resale of the forward-sold good contract; the number of times the forward-sold good contract can be transferred/resold; and a text searchable, short descriptive name to describe the forward-sold good (or service) contract. By including these parameters, the transfer/sale of the forward-sold good contract is coded for possible retransfer/resale. Further, these parameters can be entered by the merchant, as desired.

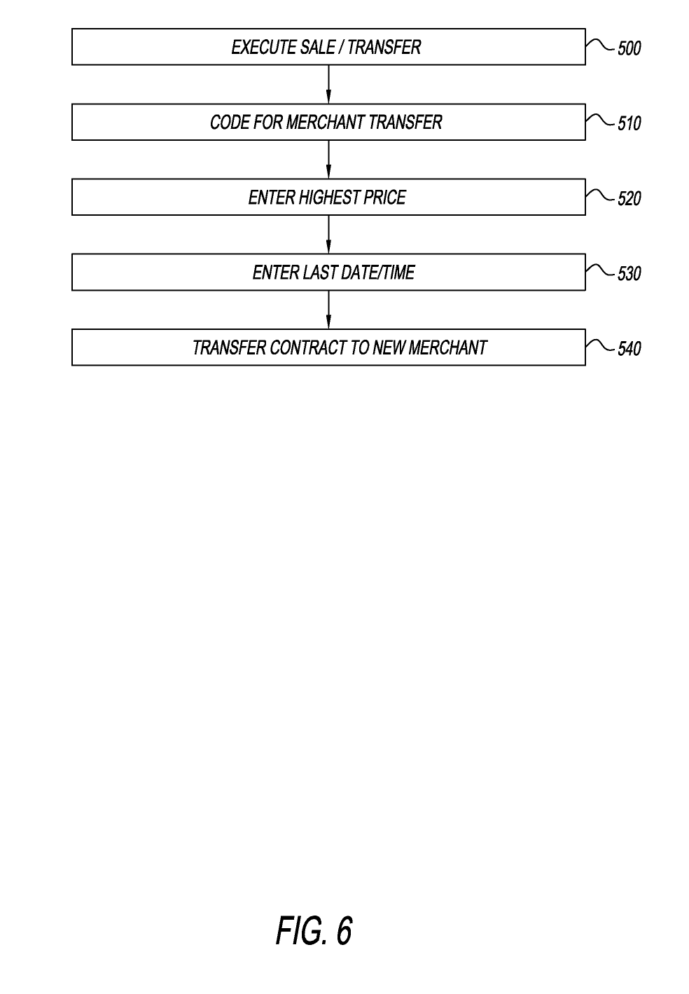

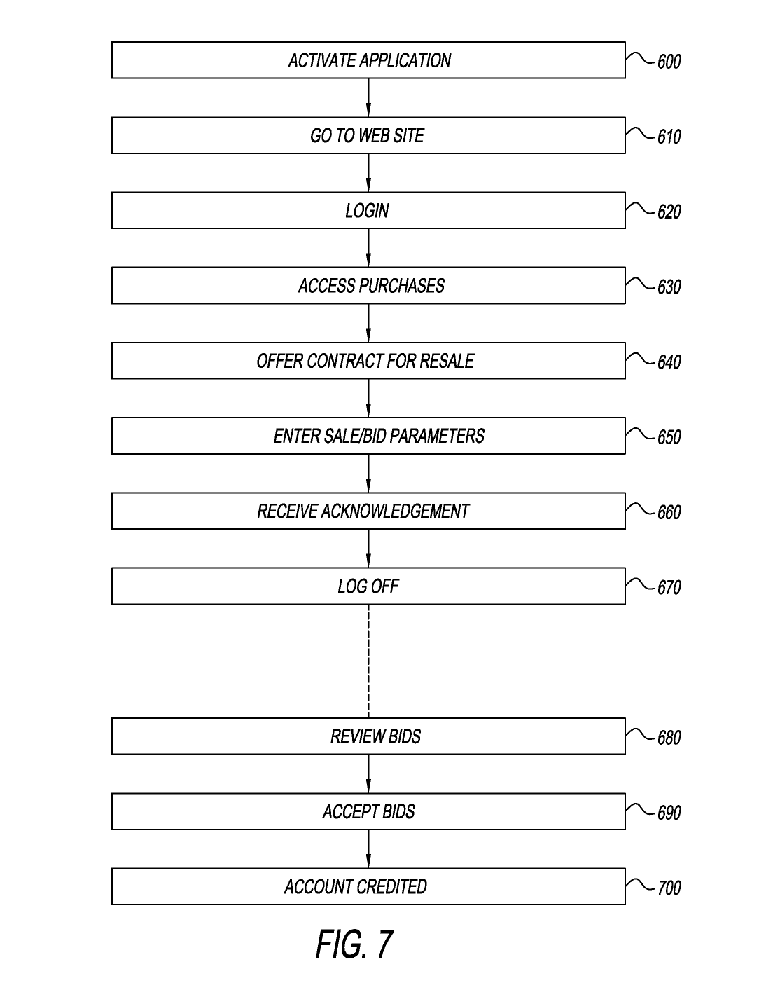

Referring again to FIG. 2, merchant transferable web site 170 has a processor 180 for assembling data from merchant transferable goods database 130 for: (a) receiving merchant input, as more fully discussed with respect to FIG. 6; (b) dealing with requests of merchants who wish to transfer goods contracts, as more fully discussed with respect to FIGS. 6 and 7; and (c) dealing with requests from merchants to purchase goods contracts available for transfer, as more fully discussed with respect to FIG. 8. A memory 185, associated with merchant transferable web site 170, having a non-transitory computer readable medium, stores computer readable instructions for use by processor 180 in implementing the operation of the disclosed embodiment.

FIG. 6 illustrates the manner in which the present method or system is used by a merchant to execute a transfer 500 as described above with respect to FIG. 2. At the discretion of the merchant, the sale is coded for permitting the transfer/resale of the forward-sold good contract at 510. At 520, the merchant provides a parameter for the highest price at which the forward-sold good contract can be transferred/resold. This can be important to the merchant for two reasons: (a) the merchant can maintain some control of the price so as not to be regarded as engaging in price gouging; and (b) for some goods, such as event prices for sports events or concerts, there may be local laws (anti-scalping laws) against resale at exorbitant prices. The merchant can best determine the nature of such restrictions on resale price, and can avoid possible fines or other penalties by entering a highest resale price.

At 530, the merchant will enter a last date and time for transfer/resale, or in the case of bidding, for submitting a bid, for the good contract to be transferred/resold. There can be practical reasons for specifying a last time that the good contract can be transferred/resold. For example, in order to assure delivery, it may be necessary to stop transfer/resale one day before the flight for a ticket for a flight on an airline, or within minutes of the start of a concert, if tickets are delivered to a mobile device in the form of a bar code for use in entering the venue of the event. Assuming the good contract is transferred/resold, at 540, the merchant of forward-sold goods transfers a contract, including consideration received from a purchaser, for the forward-sold goods to a new merchant, and the new merchant assumes the contract and thereby becomes the new supplier for the forward-sold goods.

FIG. 7 illustrates the system in accordance with the present disclosure that is used by a merchant of the good contract to make the good contract available for transfer/resale (for contracts that are not transferred/resold immediately at the time of original purchase). At 600, the original merchant or current merchant of the forward-sold good contract (a user of merchant transferable web site 170 of FIG. 2) activates an application on a mobile telephone or a computer with access to the Internet to access at 610 merchant transferable web site 170. The user logs into merchant transferable web site 170 at 620. All forward-sold good contracts owned by the merchant that can be transferred/resold are accessed at 630 by the user, under the account that was used. If the contract for the good that was sold by the merchant to the user was not coded for transfer/resale, the merchant supplements the information in transaction database 100 to code the transaction for possible transfer/resale. This information is forwarded to merchant transferable goods database 130. Thus, the merchant can offer a forward-sold good contract for transfer/resale 640 at a time after it was originally sold. Transfer, sale or bid parameters, which must be consistent with merchant guidelines, are entered at 650 by the merchant. The merchant may also enter a text searchable, short descriptive name to describe the forward-sold good (or service) contract, if not previously entered. The merchant receives an acknowledgement 660 of the transfer/resale offer, which acknowledgement includes the original transaction number and the transfer/resale parameters. The user logs off at 670.

At a later time, the merchant may log in again to review one or more bids 680 and to accept the one or more bids 690 if multiple goods contracts were offered for transfer/resale. In a simple transfer/resale situation, if an offer was accepted, the merchant will be informed of the transaction when logging in or by a push technology, and the merchant account is credited at 700 with the purchase price.

Thus, it is clear that the embodiment described herein benefits merchants. Events can occur that may make it desirable for a merchant to transfer an agreed contract with a purchaser to another merchant/supplier. Reasons why a merchant may want to transfer an agreed contract with a purchaser and thus deliver a forward-sold good to another merchant/supplier include, for example, the merchant may not have delivery capacity because of low stock levels or staffing problems or better opportunities. Conversely, a merchant may have overcapacity and wish to take on other merchants' agreed contracts to deliver a forward-sold good.

It will be understood that while this embodiment of the present disclosure has been described primarily with respect to the four party payment card system, it can be applied to a three party payment system. Further, with suitable modifications, as will be understood by one skilled in the art, it can be applied to the various kinds of payment card systems, such as credit, debit or prepaid cards.

Significantly, the transaction record is supplemented by all data relating to all subsequent transfer/resale of the good contract. In other words, all subsequent transactions are linked to the reference or transaction number of the original sale. Multiple transfer/resale events will result in a “chain” of transactions. Thus it is possible to follow the chain of transfers/resales from the original purchase transaction to the final purchase (also a resale) in order to determine the final holder of the good or service contract.

It will be understood that the disclosure is also directed to a computer readable non-transitory storage medium storing instructions of a computer program which when executed by a computer system results in performance of steps of the method described herein. Such storage media may include any mentioned in the description above.

The terms “comprises” or “comprising” are to be interpreted as specifying the presence of the stated features, integers, steps or components, but not precluding the presence of one or more other features, integers, steps or components or groups thereof.

It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A system for merchant transfer of a forward-sold good contract, comprising:
an electronic storage device having a database of information, the information includes the forward-sold good contract available for merchant transfer stored therein and parameters for merchant transfer of the forward-sold good contract;
an access path for allowing access to information concerning the forward-sold good contract; and
a processor for assembling the information to provide a merchant using the system with a capability of searching and executing a bid on the forward-sold good contract.

2. The system of claim 1 having capability for immediate merchant transfer of a forward-sold good contract.

3. The system of claim 2, further comprising setting a strike price by a merchant of the forward-sold good contract, at the time of sale of the forward-sold good, wherein the forward-sold good contract, strike price and other transaction information are conveyed to a merchant transferable website before a transferable close date, and wherein the forward-sold good contract is made immediately available for transfer to another merchant.

4. The system of claim 1, wherein the forward-sold good contract comprises payment card transactions and other transaction information including terms and conditions of the payment card transactions.

5. The system of claim 1, further comprising an additional access path for a merchant of the forward-sold good contract for use by the merchant in entering parameters for resale of the forward sold good contract in the database, to control terms of the resale.

6. The system of claim 5, wherein the parameters comprise one or more parameters selected from the group consisting of: a flag indicating that the forward-sold good contract is available for resale, a strike price for the resale purchase of the forward-sold good contract, a maximum resale price, a time by which a resale must occur, a minimum price for the resale of the forward-sold good contract, auction parameters for an auction of the forward-sold good contract, a number of times the forward-sold good contract can be resold, and a text searchable descriptive name to describe the forward-sold good contract.

7. The system of claim 1, further comprising a facility for assigning a transaction number used to access data associated with all transactions relating to the forward-sold good contract.

8. The system of claim 1, wherein the access path comprises a web site for making the information available to a user of the web site, the access path includes an Internet connected device for connecting to the web site, and wherein the Internet connected device is one device selected from the group consisting of a mobile telephone, a computer, a tablet, and a personal digital assistant.

9. A method for merchant transfer of a forward-sold good contract, comprising:
storing in an electronic storage device a database information, the information includes the forward-sold good contract available for merchant transfer and parameters for merchant transfer of the forward-sold good contract;
accessing information concerning the forward-sold good contract; and
assembling the information available for merchant transfer to provide a merchant accessing the information a capability of searching and executing a bid on the forward-sold good contract.

10. The method of claim 9 having capability for immediate merchant transfer of a forward-sold good contract.

11. The method of claim 10, further comprising setting a strike price by a merchant of the forward-sold good contract, at the time of sale of the forward-sold good, wherein the forward-sold good contract, strike price and other transaction information are conveyed to a merchant transferable website before a transferable close date, and the forward-sold good contract is made immediately available for transfer to another merchant.

12. The method of claim 9, wherein the forward-sold good contract comprises payment card transactions and other transaction information including terms and conditions of the payment card transactions.

13. The method of claim 9, further comprising entering parameters for resale of the forward-sold good contract in the database by a merchant of the forward-sold good contract, so that the parameters are transmitted by a payment network to control terms of resale of the forward-sold good contract.

14. The method of claim 9, further comprising assigning a transaction number used to access data associated with all transactions relating to the forward-sold good contract.

15. The method of claim 9, further comprising filtering the information to remove confidential cardholder information.

16. The method of claim 13, wherein the parameters comprise one or more parameters selected from the group consisting of: a flag indicating that the forward-sold good contract is available for resale, a strike price for the resale purchase of the forward-sold good contract, a maximum resale price, a time by which a resale must occur, a minimum price for the resale of the forward-sold good contract, auction parameters for an auction of the forward-sold good contract, a number of times the forward-sold good contract can be resold, and a text searchable descriptive name to describe the forward-sold good contract.

17. The method of claim 9, wherein the accessing is performed using a web site for making the information concerning the transactions available to a user of the web site, the accessing information is by use of an Internet connected device for connecting to the web site, and wherein the Internet connected device is one device selected from the group consisting of a mobile telephone, a computer, a tablet, and a personal digital assistant.

18. A computer readable non-transitory storage medium for storing instructions of a computer program that when executed by a computer enables merchant transfer of a forward-sold good contract, the medium comprising:
instructions for causing an electronic storage device to store a database of information of the forward-sold good contract, the information including payment card transactions and parameters for merchant transfer of the forward-sold good contract available for merchant transfer;
instructions for providing an access path for allowing access to the information concerning the forward-sold good contract; and
instructions for assembling the information concerning the forward-sold good contract to provide a merchant accessing the information a capability of searching and executing a bid on the forward-sold good contract.

19. The computer readable non-transitory storage medium for storing instructions of a computer program of claim 18 that when executed by a computer enables immediate merchant transfer of a forward-sold good contract.

20. The computer readable non-transitory storage medium for storing instructions of a computer program of claim 18, further comprising instructions that when executed by the computer provide an access path for a merchant of the goods sold to enter parameters regarding the resale of the forward-sold good contract.
